(19) United States
(12) Patent Application Publication
(10) Pub. No.: US 2006/0186809 A1
(43) Pub. Date: Aug. 24, 2006

(54) Plasma display panel

(76) Inventors: Tae-Woo Kim, Suwon-si (KR); Jeong-Nam Kim, Suwon-si (KR); Byoung-Min Chun, Suwon-si (KR); Jeong-Doo Yi, Suwon-si (KR)

Correspondence Address: LEE & MORSE, P.C., 1101 WILSON BOULEVARD, SUITE 2000, ARLINGTON, VA, 22209, US

(21) Appl. No.: 11/319,576

(22) Filed: Dec. 29, 2005

(30) Foreign Application Priority Data
Feb. 22, 2005 (KR) 10-2005-0014429

(51) Int. Cl. H01J 17/49

(52) U.S. Cl. 313/582

(57) ABSTRACT

A plasma display panel includes first and second substrates opposite each other, address electrodes on the first substrate in a first direction, barrier ribs between the first and second substrates to partition discharge cells, phosphor layers in the discharge cells, and first and second electrodes on the second substrate and extending in a second direction intersecting the first direction and alternately arranged in the first direction. Each of the first and second electrodes includes a bus electrode extending in the second direction, and an extension electrode that protrudes from the bus electrode in the first direction towards a corresponding discharge cell. Each bus electrode includes at least two bus electrode portions that are electrically connected to each other and that are separated from each other by a predetermined gap.

### BACKGROUND OF THE INVENTION

1. Field of the Invention

The present invention relates to a plasma display panel for displaying images.

2. Description of Related Art

In general, a plasma display panel is a display device that displays images using visible light generated by exciting a phosphor layer with vacuum ultraviolet (VUV) light emitted from plasma generated by a gas discharge.

The plasma display panel generally has a three-electrode surface discharge structure. The three-electrode surface discharge structure includes a front substrate having display electrodes thereon, each display electrode including two electrodes, and a rear substrate, separated from the front substrate by a predetermined distance, having address electrodes thereon. In addition, a space between the two substrates is partitioned by barrier ribs into a plurality of discharge cells. Each discharge cell has a phosphor layer therein and is filled with a discharge gas. The plasma display panel includes several millions or more unit discharge cells arranged in a matrix and uses a memory characteristic to simultaneously drive the discharge cells.

However, the plasma display panel performs many processes to obtain visible light and consumes a large amount of power during these processes. Therefore, the plasma display panel has a low degree of efficiency. Further, external light is reflected from the front substrate, which lowers contrast.

### SUMMARY OF THE INVENTION

The present invention is therefore directed to plasma display panel, which substantially overcomes one or more of the problems due to the limitations and disadvantages of the related art.

It is a feature of an embodiment of the present invention to provide a plasma display panel having a reduced electrode area.

It is another feature of an embodiment of the present invention to provide a plasma display panel that reduces power consumption.

It is still another feature of an embodiment of the present invention to provide a plasma display panel that prevents reflection of external light from a front substrate.

It is yet another feature of an embodiment of the present invention to provide a plasma display panel having improved contrast.

At least one of the above and other features and advantages of the present invention may be realized by providing a plasma display panel including first and second substrates arranged opposite to each other, address electrodes on the first substrate in a first direction, barrier ribs in a space between the first and second substrates to partition discharge cells, phosphor layers in the discharge cells, and first and second electrodes on the second substrate in a second direction intersecting the first direction, the first and second electrodes being alternately arranged in the first direction. Each of the first and second electrodes includes a bus electrode extending in the second direction, the bus electrode having at least two bus electrode portions that are electrically connected to each other and are separated from each other by a predetermined gap, and an extension electrode protruding from the bus electrode in the first direction towards a corresponding discharge cell.

Each bus electrode may include only a first bus electrode portion and a second bus electrode portion.

The bus electrode portions constituting each bus electrode may be connected to each other around an edge portion of the second substrate. The second substrate may include a first edge portion and a second edge portion opposite to the first edge portion. The bus electrode portions constituting the bus electrode of the first electrode may be connected to each other around the first edge portion of the second substrate, and the bus electrode portions constituting the bus electrode of the second electrode may be connected to each other around the second edge portion of the second substrate.

Each of the first electrodes and the second electrodes may be commonly used by discharge cells adjacent to each other in the first direction.

The barrier ribs may include first barrier rib members along the first direction and second barrier rib members along the second direction, and the bus electrodes of the first electrodes and the second electrodes may correspond to and may be aligned with the second barrier rib members.

The plasma display panel may further include third electrodes between the first electrodes and second electrodes and corresponding to the discharge cells.

The plasma display panel may further include black layers in the second direction between the at least two bus electrode portions. The black layer and the bus electrode portions may be separated from each other or each black layer may partially cover the bus electrode portions. The black layer may be formed in a non-discharge region, e.g., corresponding to the second barrier rib members. The black layer may be an insulating material.

Each extension electrode may include extension electrode portions that respectively project from the bus electrode portions and are separated from each other by the discharge cells adjacent to each other in the first direction or each extension electrode may be a single electrode commonly used by the discharge cells adjacent to each other in the first direction, the bus electrode portions of the bus electrodes being on the extension electrodes.

Each black layer may be between the extension electrode portions or on the extension electrode. Each black layer on the extension electrode may be separated from the bus electrode portions or may partially cover the bus electrode portions.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a partially exploded perspective view of a plasma display panel according to a first embodiment of the invention;

FIG. 2 illustrates a partial bottom view of the plasma display panel according to the first embodiment of the invention;

FIG. 3 illustrates a partial cross-sectional view taken along the line III-III of FIG. 1;

FIG. 4 illustrates a partial cross-sectional view of a plasma display panel according to a second embodiment of the invention;

FIG. 5 illustrates a partial cross-sectional view of a plasma display panel according to a third embodiment of the invention;

FIG. 6 illustrates a partial cross-sectional view of a plasma display panel according to a fourth embodiment of the invention; and

FIG. 7 illustrates a partial cross-sectional view of a plasma display panel according to a fifth embodiment of the invention.

### DETAILED DESCRIPTION OF THE INVENTION

Korean Patent Application No. 10-2005-0014429, filed in the Korean Intellectual Property Office on Feb. 22, 2005, and entitled “Plasma Display Panel,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. Like reference numerals refer to like elements throughout.

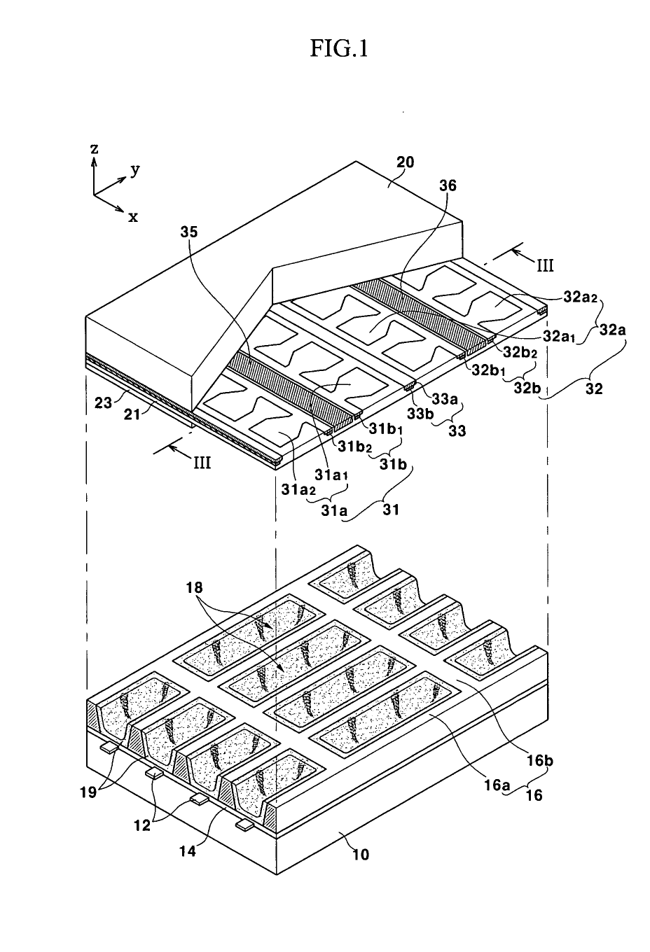

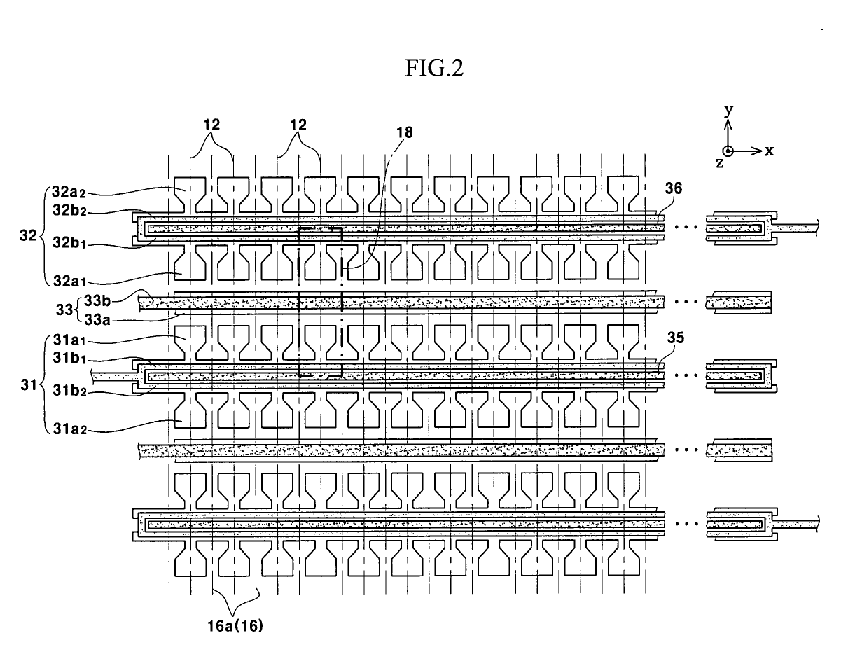

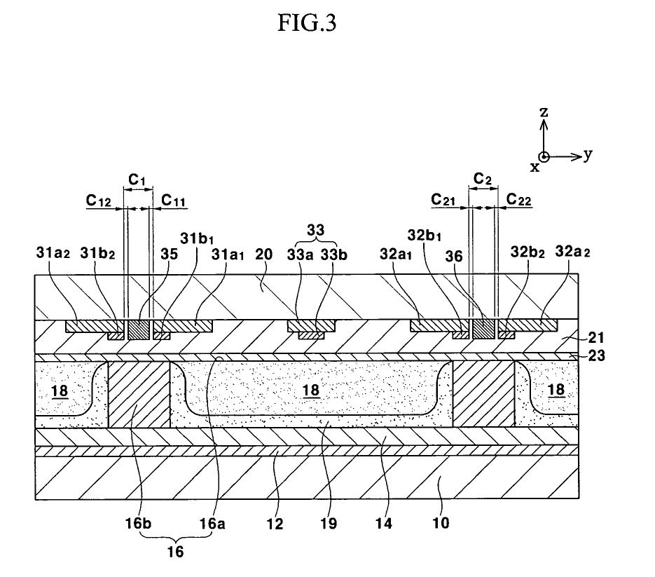

FIG. 1 illustrates an exploded perspective view of a plasma display panel according to a first embodiment of the invention. FIG. 2 illustrates a partial bottom view of the plasma display panel according to the first embodiment of the invention. FIG. 3 illustrates a cross-sectional view taken along the line III-III of FIG. 1. The plasma display panel according to the first embodiment will be described with reference to these drawing figures.

The plasma display panel of the first embodiment of the present invention includes a first substrate 10 (hereinafter, referred to as a “rear substrate”) and a second substrate 20 (hereinafter, referred to as a “front substrate”) arranged opposite to each other with a predetermined gap between them. Barrier ribs 16 may be provided between the rear substrate 10 and the front substrate 20. The barrier ribs 16 define a plurality of discharge cells 18 between the rear substrate 10 and the front substrate 20. Phosphor layers 19, which absorb vacuum ultraviolet (VUV) light and emit visible light, may be provided in each discharge cell 18. The discharge cells 18 may be filled with a discharge gas, e.g., a mixture of neon (Ne) and xenon (Xe). The discharge gas generates the VUV light by plasma discharge.

The barrier ribs 16 partitioning the discharge cells 18 may be formed in a closed barrier rib structure in which the discharge cells are partitioned independently or in an open barrier rib structure in which the discharge cells are partitioned to be connected in one direction. A closed barrier rib structure is illustrated in FIG. 1. The closed barrier rib structure enables the discharge cells to be formed in various shapes, e.g., rectangles or hexagons. In the exemplary embodiment shown in FIG. 1, the discharge cells 18 are rectangular.

In the first embodiment, the barrier ribs 16 include first barrier rib members 16a arranged in a first direction, i.e., a y-axis direction of the drawings, and second barrier rib members 16b arranged in a second direction, i.e., a x-axis direction of the drawings, intersecting the first direction to partition the discharge cells 18, resulting in discharge cells 18 having independent discharge spaces.

Further, in the first embodiment, in order to generate the VUV light to collide with the phosphor layer 19 by plasma discharge, address electrodes 12 may be formed on the rear substrate 10, and first electrodes 31, second electrodes 32 and third electrodes 33 may be formed on the front substrate 20.

The address electrodes 12 may be formed on the rear substrate 10 extending in a first direction along the discharge cells 18. In addition, adjacent address electrodes 12 may be arranged parallel to and spaced from each other. Each address electrode 12 may be arranged between a pair of first barrier rib members 16a. A dielectric layer 14 may be formed on the address electrodes 12. The phosphor layer 19 may be formed on the surface of the dielectric layer 14 in the respective discharge cells 18 and on inner surfaces of the barrier ribs 16 formed on the dielectric layer 14.

The first electrodes 31 and the second electrodes 32 may be formed on the front substrate 20 along the second direction. The first electrodes 31 and the second electrodes 32 may be arranged at both sides of each of the discharge cells 18 arranged in the first direction, and may be alternately arranged in the first direction.

Each of the first electrodes 31 and the second electrodes 32 may be commonly used by the discharge cells 18 adjacent to each other in the first direction, and may be arranged along second barrier rib members 16b. The first electrodes 31 may include bus electrodes 31b and extension electrodes 31a, and the second electrodes 32 may include bus electrodes 32b and extension electrodes 32a.

The bus electrodes 31b and 32b may be formed to extend in the second direction, corresponding to the second barrier rib members 16b, and the extension electrodes 31a and 32a may protrude from the bus electrodes 31b and 32b toward the inside of each discharge cell 18, respectively. In the first embodiment, the extension electrodes 31a and 32a may be formed corresponding to the discharge cells 18, to be partitioned by the discharge cells 18. However, the invention is not limited to this structure, and the extension electrodes may be formed in alternative shapes, e.g., stripes.

The extension electrodes 31a and 32a function to generate a plasma discharge in the discharge cells 18, and may be made of a transparent material having high transmittance, e.g., ITO (indium tin oxide), in order to insure sufficient brightness. The bus electrodes 31b and 32b may include a material having high electrical conductivity, e.g., metal, in order to compensate for a lower electrical conductivity of the extension electrodes 31a and 32a.

Further, the third electrodes 33 may correspond to respective discharge cells 18 and may be disposed in the second direction and between the first electrodes 31 and the second electrodes 32. Specifically, the third electrodes 33 may be formed to correspond to the centers of the discharge cells 18. Each of the third electrodes 33 may include a bus electrode 33b and an extension electrode 33a, similar to the first and second electrodes 31 and 32. In the first embodiment, the extension electrode 33a of the third electrode 33 may protrude from both sides of the bus electrode 33b toward the first electrode 31 and the second electrode 32, respectively.

During an address period, the discharge cells to be turned on may be selected by an address discharge occurring between the address electrodes 12 and the third electrodes 33. During a sustain period, an image may be displayed by a sustain discharge occurring between the first electrodes 31 and the second electrodes 32. However, the respective electrodes can perform different functions according to a signal voltage to be applied, so that the invention is not limited to the above-mentioned structure.

In the first embodiment, the bus electrodes 31b and 32b of the first electrodes 31 and the second electrodes 32 may be formed in non-discharge regions to increase an emission area and an aperture ratio, which results in a high-brightness display. In addition, the bus electrodes 31b and 32b of the first electrodes 31 and the second electrodes 32 may be formed corresponding to the second barrier rib members 16b, so that the main discharge length can increase during the sustain discharge, thereby improving luminous efficiency.

The bus electrodes 31b and 32b and the extension electrodes 31a and 32a constituting the first and second electrodes 31 and 32 will be described in more detail below.

Each bus electrode 31b of the first electrodes 31 may include a first bus electrode portion 31b₁ and a second bus electrode portion 31b₂ separated from each other by a predetermined gap C₁. The first bus electrode portion 31b₁ and the second bus electrode portion 31b₂ may be connected to each other, and the same voltage may be applied thereto. For example, the first and second bus electrode portions 31b₁ and 31b₂ may be connected to each other around a first edge portion of the front substrate 20.

Similarly, each bus electrode 32b of the second electrode 32 may include a first bus electrode portion 32b, and a second bus electrode portion 32b₂ separated from each other by a predetermined gap C₂. The first bus electrode portion 32b, and the second bus electrode portion 32b₂ of the second electrode 32 may be connected to each other, and the same voltage may be applied thereto. For example, the first and second bus electrode portions 32b₁ and 32b₂ may be connected to each other around a second edge portion of the front substrate 20 opposite to the first edge portion.

In the first embodiment, the bus electrodes 31b may be divided into the bus electrode portions 31b₁ and 31b₂, and the bus electrodes 32b may be divided 32b₁, and 32b₂, which results in a reduction in the area of the bus electrodes 31b and 32b.

Further, the extension electrodes 31a and 32a may include first extension electrode portions 31a₁ and 32a₁ projecting from the first bus electrode portions 31b₁ and 32b₁ toward the inside of each discharge cell 18, and second extension electrode portions 31a₂ and 32a₂ projecting from the second bus electrode portions 31b₂ and 32b₂ toward the inside of each discharge cell 18, respectively. That is, in the first embodiment, the extension electrodes 31a and 32a constituting the first electrodes 31 and the second electrodes 32 include first extension electrode portions 31a₁ and 32a₁ and second extension electrode portions 31a₂ and 32a₂ that are separated from each other by the discharge cells 18 adjacent to each other in the first direction and that correspond to the discharge cells 18, respectively.

In the first embodiment, first black layers 35 may be formed between the bus electrode portions 31b₁ and 31b₂ constituting the bus electrodes 31b of the first electrode 31 so as to be parallel thereto. Similarly, second black layers 36 may be formed between the bus electrode portions 32b₁ and 32b₂ constituting the bus electrodes 32b of the second electrode 32 so as to be parallel thereto. More specifically, in the first electrode 31, the first black layer 35 may be formed between the first extension electrode portion 31a, and the second extension electrode portion 31a₂ and between the first bus electrode portion 31b₁ and the second bus electrode portion 31b₂. In the second electrode 32, the second black layer 36 may be formed between the first extension electrode portion 32a₁ and the second extension electrode portion 32a₂ and between the first bus electrode portion 32b, and the second bus electrode portion 32b₂.

Further, the first black layer 35 and the first bus electrode portion 31b₁ of each first electrode 31 may be separated from each other by a predetermined gap C₁₁, and the first black layer 35 and the second bus electrode portion 31b₂ of each first electrode 31 may be separated from each other by a predetermined gap C₁₂. In this way, it is possible to further reduce the area of the bus electrode 31b by an area corresponding to the area of the first black layer 35 and the area of the gaps C₁₁ and C₁₂ formed at both sides of the first black layer 35. Therefore, the capacitance of the first electrode 31 may be reduced when the plasma display panel is driven, thereby reducing power consumption.

Similarly, the second black layer 36 and the first bus electrode portion 32b₁ of each second electrode 32 may be separated from each other by a predetermined gap C₂₁, and the second black layer 36 and the second bus electrode portion 32b₂ of each second electrode 32 may be separated from each other by a predetermined gap C₂₂. In this way, it is possible to reduce the area of the bus electrode 32b by an area corresponding to the area of the second black layer 36 and the area of the gaps C₂, and C₂₂ formed at both sides of the second black layer 36. Therefore, the capacitance of the second electrode 32 may be reduced when the plasma display panel is driven, thereby reducing power consumption.

In order to effectively reduce power consumption as described above, the first black layer 35 and the second black layer 36 may be made of an insulating material.

In the first embodiment, since the first black layer 35 and the second black layer 36 are formed along the second barrier ribs 16b, which are non-discharge regions, it is possible to prevent reflection of external light without shielding visible rays generated by the plasma discharge. Thus, contrast may be improved without lowering brightness.

The first electrodes 31, the second electrodes 32 and the third electrodes 33 may be covered with a dielectric layer 21. The dielectric layer 21 may be covered with a protective film 23. The dielectric layer 21 may be made of a transparent dielectric for protecting electrodes, generating and charging of wall charges, and realizing high transmittance. The protective film 23 may be an MgO protective film to protect the electrodes 31, 32, and 33 and the dielectric layer 21, and to effectively emit secondary electrons during plasma discharge.

Hereinafter, plasma display panels according to second to fifth embodiments of the invention will be described in detail. In these embodiments, the plasma display device has the same overall structure as that in the first embodiment. Thus, only components different from those in the first embodiment will be described in detail below.

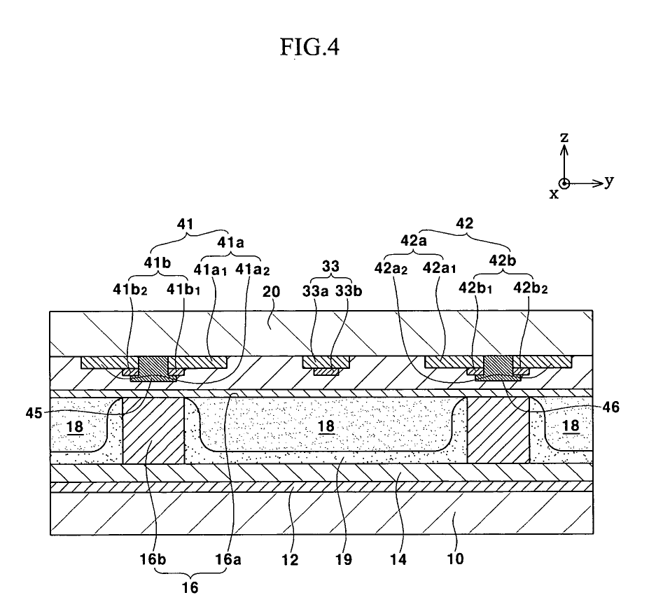

FIG. 4 illustrates a partial cross-sectional view of a plasma display panel according to the second embodiment of the invention.

In the second embodiment, a first black layer 45 may partially cover a first bus electrode portion 41b₁ and a second bus electrode portion 41b₂ constituting a bus electrode 41b of a first electrode 41. Similarly, a second black layer 46 may partially cover a first bus electrode portion 42b, and a second bus electrode portion 42b₂ constituting a bus electrode 42b of a second electrode 42. In the second embodiment, extension electrodes 41a may include first extension electrode portions 41a₁, and second extension electrode portions 41a₂, extension electrodes 42a may include first extension electrode portions 42a, and second extension electrode portions 42a₂. The first extension electrode portion 41a₁, 41a₂, 42a₁, 42a₂ may be separated from each other by the discharge cells 18 adjacent to each other in the first direction and that correspond to the discharge cells 18, respectively.

Again, the first black layer 45 and the second black layer 46 may be made of an insulating material. In the second embodiment, the first and second black layers 45, 46 have larger widths as compared with the first embodiment, thereby simplifying alignment between the front substrate 20 and the rear substrate 10.

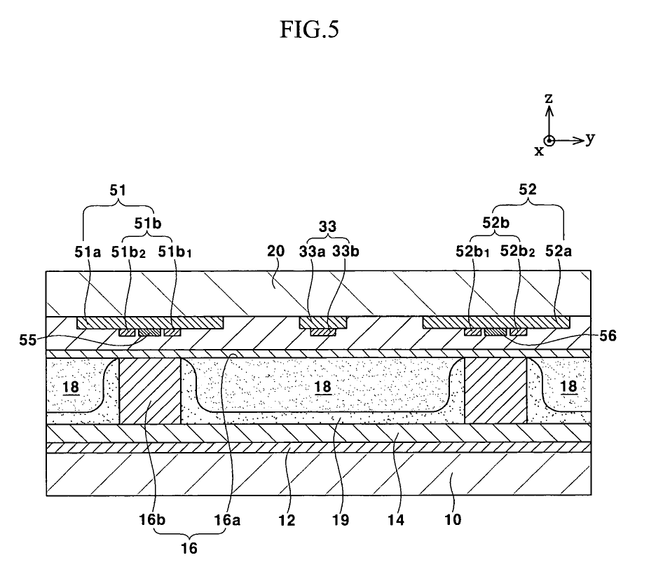

FIG. 5 illustrates a partial cross-sectional view of a plasma display panel according to the third embodiment of the invention.

In the third embodiment, extension electrodes 51a and 52a of a first electrode 51 and a second electrode 52 may be commonly used by the discharge cells 18 adjacent to each other in the first direction, and each may be formed as a single electrode. In addition, first bus electrode portions 51b₁ and second bus electrode portions 51b₂ constituting bus electrodes 51b may be formed on the extension electrodes 51a, first bus electrode portions 52b₁ and second bus electrode portions 52b₂ constituting bus electrodes 52b may be formed on the extension electrodes 52a. A first black layer 55 may be formed between the first bus electrode portion 51b₁ and the second bus electrode portion 51b₂, and a second black layer 56 may be formed between the first bus electrode portion 52b₁ and the second bus electrode portion 52b₂ on the extension electrodes 51a and 52a.

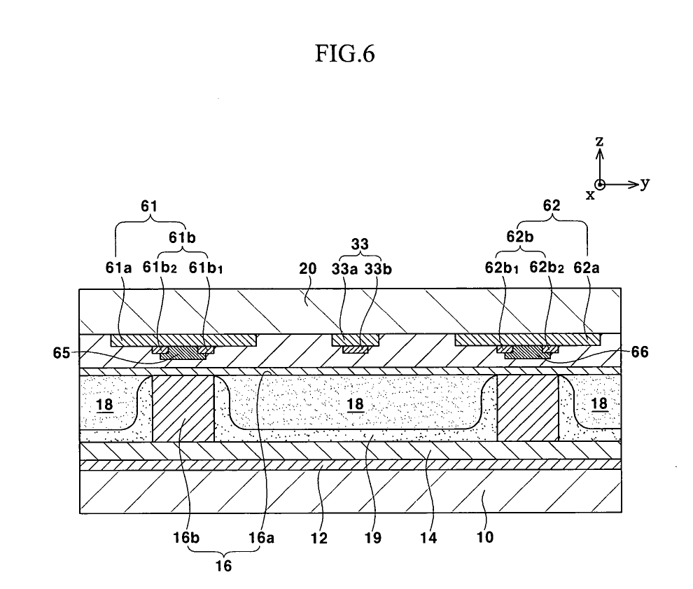

FIG. 6 illustrates a partial cross-sectional view of a plasma display panel according to the fourth embodiment of the invention.

In the fourth embodiment, extension electrodes 61a and 62a of a first electrode and a second electrode may be commonly used by the discharge cells 18 adjacent to each other in the first direction, and each may be formed as a single electrode. In addition, a first black layer 65 may be formed on the extension electrodes 61a so as to partially cover first bus electrode portions 61b₁ and second bus electrode portions 61b₂ constituting the bus electrodes 61b. Similarly, a second black layer 66 may be formed on the extension electrodes 61a so as to partially cover first bus electrode portions 62b₁ and second bus electrode portions 62b₂ constituting the bus electrodes 62b.

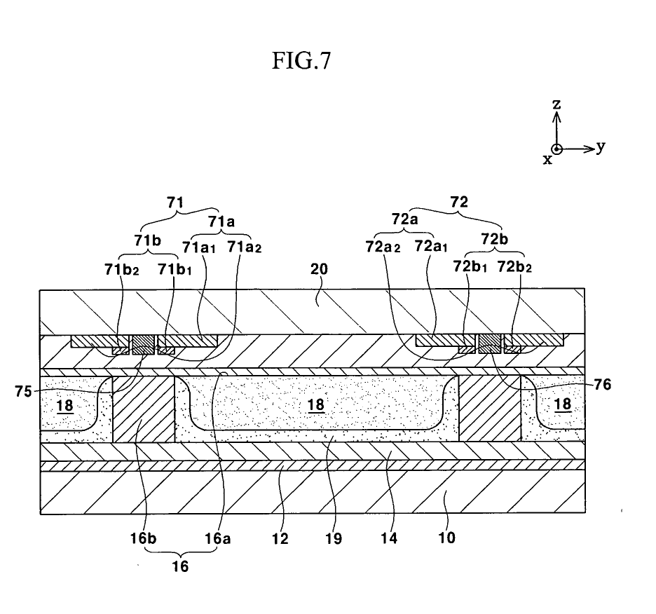

FIG. 7 illustrates a partial cross-sectional view of a plasma display panel according to the fifth embodiment of the invention.

In the fifth embodiment, address electrodes 12, first electrodes 71, and second electrodes 72 participate in discharge. The first electrodes 71 include extension electrodes 71a and bus electrodes 71b, and the second electrodes 72 include extension electrodes 72a and bus electrodes 72b. In addition, the extension electrodes 71a include first extension electrode portions 71a₁ and second extension electrode portions 71a₂, and the extension electrodes 72a include first extension electrode portions 72a₁ and second extension electrode portions 72a₂. The bus electrodes 71b include first bus electrode portions 71b₁ and second bus electrode portions 71b₂, and the bus electrodes 72b include first bus electrode portions 72b₁ and second bus electrode portions 72b₂.

The plasma display panel of the fifth embodiment has a three-electrode structure, and may be designed such that each discharge cell 18 is driven by one sub-pixel or a pair of discharge cells 18 adjacent to each other in the first direction is driven by one sub-pixel.

In the fifth embodiment, the structure of the first and second electrodes 71 and 72 is the same as that in the first embodiment, but without the third electrode 33. However, the invention is not limited thereto, and so the first and second electrodes 71 and 72 may have the same structure as the first and second electrodes described in the second to fourth embodiments.

Exemplary embodiments of the present invention have been disclosed herein, and although specific terms are employed, they are used and are to be interpreted in a generic and descriptive sense only and not for purpose of limitation. For example while the bus electrodes described above each include a first bus electrode portion and a second bus electrode portion, all cases in which each bus electrode includes at least two or more bus electrode portions are included in the scope of the invention. Accordingly, it will be understood by those of ordinary skill in the art that various changes in form and details may be made without departing from the spirit and scope of the present invention as set forth in the following claims.

What is claimed is:

1. A plasma display panel comprising:
first and second substrates arranged opposite to each other;
address electrodes on the first substrate in a first direction;
barrier ribs in a space between the first and second substrates to partition discharge cells;
phosphor layers in the discharge cells; and
first and second electrodes on the second substrate in a second direction intersecting the first direction, the first and second electrodes being alternately arranged in the first direction, wherein each of the first and second electrodes includes:
a bus electrode extending in the second direction, the bus electrode having at least two bus electrode portions that are electrically connected to each other and are separated from each other by a predetermined gap, and
an extension electrode protruding from the bus electrode in the first direction towards a corresponding discharge cell.

2. The plasma display panel according to claim 1, wherein each bus electrode includes a first bus electrode portion and a second bus electrode portion.

3. The plasma display panel according to claim 1, wherein the bus electrode portions of each bus electrode are connected to each other around an edge portion of the second substrate.

4. The plasma display panel according to claim 3, wherein:
the second substrate includes a first edge portion and a second edge portion opposite to the first edge portion,
the bus electrode portions of the bus electrode of the first electrode are connected to each other around the first edge portion of the second substrate, and
the bus electrode portions of the bus electrode of the second electrode are connected to each other around the second edge portion of the second substrate.

5. The plasma display panel according to claim 1, wherein each of the first electrodes and the second electrodes is commonly used by discharge cells adjacent to each other in the first direction.

6. The plasma display panel according to claim 1, wherein:
the barrier ribs include first barrier rib members along the first direction and second barrier rib members along the second direction, and
the bus electrodes of the first electrodes and the second electrodes correspond to the second barrier rib members.

7. The plasma display panel according to claim 6, wherein the bus electrodes are aligned with the second barrier rib members.

8. The plasma display panel according to claim 1, further comprising third electrodes between the first electrodes and second electrodes and corresponding to the discharge cells.

9. The plasma display panel according to claim 1, further comprising a black layer in the second direction between the at least two bus electrode portions.

10. The plasma display panel according to claim 9, wherein the black layer and the bus electrode portions are separated from each other.

11. The plasma display panel according to claim 9, wherein each black layer partially covers the bus electrode portions.

12. The plasma display panel according to claim 9, wherein:
each extension electrode includes extension electrode portions that respectively project from the bus electrode portions and are separated from each other by the discharge cells adjacent to each other in the first direction, and
each black layer is provided between the extension electrode portions.

13. The plasma display panel according to claim 9, wherein:
each extension electrode is a single electrode and is commonly used by discharge cells adjacent to each other in the first direction, the bus electrode portions of the bus electrodes being on the extension electrodes, respectively, and
each black layer is on the extension electrode.

14. The plasma display panel according to claim 13, wherein each black layer is separated from the bus electrode portions.

15. The plasma display panel of claim 13, wherein each black layer further partially covers the bus electrode portions.

16. The plasma display panel according to claim 9, wherein the black layer is formed in a non-discharge region.

17. The plasma display panel according to claim 16, wherein;
the barrier ribs include first barrier rib members formed along the first direction and second barrier rib members formed along the second direction, and
the black layers are formed corresponding to the second barrier rib members.

18. The plasma display panel according to claim 9, wherein the black layers are made of an insulating material.

19. The plasma display panel according to claim 1, wherein each extension electrode includes extension electrode portions that respectively project from the bus electrode portions and are separated from each other by the discharge cells adjacent to each other in the first direction.

20. The plasma display panel according to claim 1, wherein each extension electrode is a single electrode and is commonly used by the discharge cells adjacent to each other in the first direction, the bus electrode portions of the bus electrodes being on the extension electrodes, respectively.
